(19) United States
(12) Patent Application Publication
(10) Pub. No.: US 2010/0114687 A1
(43) Pub. Date: May 6, 2010

(54) SYSTEM FOR USE IN DEFINING PRODUCTS AND BILLING FOR THE SAME

(75) Inventors: Mauricio Zamora, Chicago, IL (US); Scott Prugh, Chicago, IL (US); Jason Johs, Naperville, IL (US)

Correspondence Address: GREENBERG TRAURIG, LLP, 77 WEST WACKER DRIVE, SUITE 3100, CHICAGO, IL, 60601-1732, US

(73) Assignee: CGS Systems, Inc., Englewood, CO (US)

(21) Appl. No.: 12/552,148

(22) Filed: Sep. 1, 2009

Related U.S. Application Data
(60) Provisional application No. 61/190,721, filed on Sep. 2, 2008.

(51) Int. Cl. G06Q 30/00; G06Q 50/00; G06Q 10/00; G06F 3/01

(52) U.S. Cl. 705/14.23; 705/26; 705/304; 715/705

(57) ABSTRACT

A system for defining products and billing for the same includes a server and an associated database. The server has programming to provide an interactive wizard which is used define and modify: a first data set including data indicative of a plurality of products to be offered to a customer; a second data set including data indicative of product bundles including selected ones of the plurality of products to be offered to a customer; a third data set including data indicative of prices associated with the plurality of products and product bundles; a fourth data set including data indicative of how the plurality of products and product bundles are to be billed to a customer; and a fifth data set including data indicative of how the plurality of products and product bundles are offered to a customer for purchase. The database stores the data sets and a mapping therebetween.

### RELATED APPLICATION INFORMATION

This application claims the benefit of U.S. Provisional Application No. 61/190,721, filed on Sep. 2, 2008, the disclosure of which is incorporated herein by reference in its entirety.

### BACKGROUND

In the art, systems and methods for bundling together a number of products and making the bundle available for purchase by a consumer are known. For example, U.S. Published Application No. 2008/0288372 describes an electronic commerce system in which an external administrator can bundle together a number of products offered by a vendor via electronic commerce to produce a virtual bundle. The virtual bundle of products can then be offered for sale at an electronic commerce site by a vendor.

### SUMMARY

The following describes an improved system that provides tools, generally in the form of wizards, that allow for the defining of products, product offerings, product pricing, and product billing. The wizards also allow for the organization of the defined data as well as for the modification of the same. Data is thus created, stored, and accessed in a manner that allows for bundles of products to be conveniently offered to a customer and to be billed for. In addition, the resulting organized data allows a customer service representative to conveniently access and view information in a manner that facilitates the offering of the products to the customer.

### BRIEF DESCRIPTION OF THE DRAWINGS

For a better understanding of the system and method for use in defining products and billing for the same, reference may be had to the following drawings in which:

FIG. 1 illustrates a block diagram of an exemplary system in which the inventive concepts of the subject invention may be employed;

FIG. 2 illustrates a block diagram of data components and relationships therebetween which are creatable and manageable via use of the system illustrated in FIG. 1;

FIGS. 3-6 illustrate screen shots of wizard pages used to define a product and pricing therefor;

FIGS. 7-11 illustrate screen shots of wizard pages used to define a product bundle and pricing therefor; and

FIGS. 12-21 illustrate screen shots of wizard pages used to define a product offering and pricing therefor.

### DETAILED DESCRIPTION

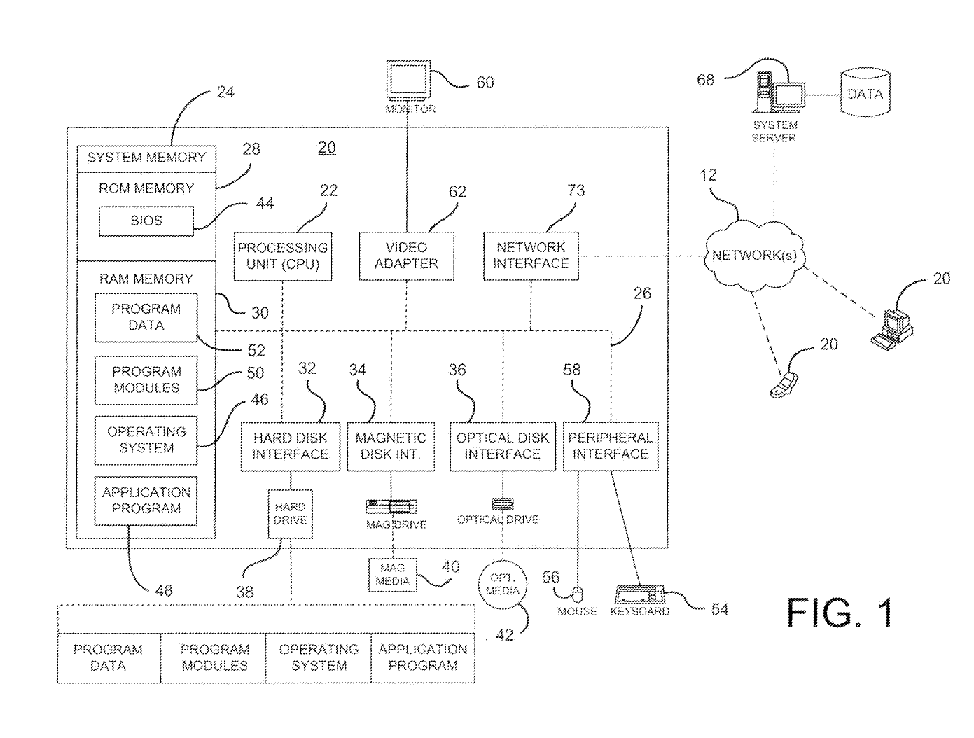

Turning to the drawings an exemplary system and method for use in defining products and billing for the same is now described. As illustrated in FIG. 1, an exemplary system in which the subject inventive concepts may be employed includes a processing device 20, illustrated in detail by way of example only as a computer system, that is provided with executable instructions to, for example, provide a means for a customer service representative to access data pertaining to products, bundles, pricing, and related offerings that may be made available for purchase and/or provide a means for a configuration administrator to access and interact with the wizards hereinafter described to define such products, bundles, pricing, and related offerings. To this end, the processing device 20 is linked, via a network 12, to a computer system/server 68 that, in turn, is associated with a database. Generally, the computer executable instructions of processing device 20 reside in program modules which may include routines, programs, objects, components, data structures, etc. that perform particular tasks or implement particular abstract data types. Accordingly, those skilled in the art will appreciate that the processing device 20 may be embodied in any device having the ability to execute instructions such as, by way of example, a personal computer, mainframe computer, personal-digital assistant (PDA), cellular telephone, or the like. Furthermore, while described and illustrated in the context of a single processing device 20, those skilled in the art will also appreciate that the various tasks described hereinafter may be practiced in a distributed environment having multiple processing devices linked via a local or wide-area network whereby the executable instructions may be associated with and/or executed by one or more multiple processing devices.

For performing the various tasks in accordance with the executable instructions, a processing device 20 may include a processing unit 22 and a system memory 24 which may be linked via a bus 26. Without limitation, the bus 26 may be a memory bus, a peripheral bus, and/or a local bus using any of a variety of well known bus architectures. As needed for any particular purpose, the system memory 24 may include read only memory (ROM) 28 and/or random access memory (RAM) 30. Additional memory devices may also be made accessible to the processing device 20 by means of, for example, a hard disk drive interface 32, a magnetic disk drive interface 34, and/or an optical disk drive interface 36. As will be understood, these devices, which would be linked to the system bus 26, respectively allow for reading from and writing to a hard disk 38, reading from or writing to a removable magnetic disk 40, and for reading from or writing to a removable optical disk 42, such as a CD/DVD ROM or other optical media. The drive interfaces and their associated computer-readable media allow for the nonvolatile storage of computer readable instructions, data structures, program modules and other data for the processing device 20. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, and other read/write and/or read-only memories.

A number of program modules, i.e., computer executable instructions, may be stored in one or more of the memory/media devices of the processing device 20. For example, a basic input/output system (BIOS) 44, containing the basic routines that help to transfer information between elements within the processing device 20, such as during start-up, may be stored in ROM 28. Similarly, the RAM 30, hard drive 38, and/or peripheral memory devices may be used to store computer executable instructions comprising an operating system 46, one or more applications programs 48 (such as a Web browser), other program modules 50, and/or program data 52. Still further, computer-executable instructions may be downloaded to the processing device 20 as needed, for example, via a network connection.

The customer service representative and/or configuration administrator may enter commands and information into the processing device 20 through input devices such as a keyboard 54 and/or a pointing device 56. While not illustrated, other input devices may include a microphone, a joystick, a game pad, a scanner, etc. These and other input/output devices would typically be connected to the processing unit 22 by means of an interface 58 which, in turn, would be coupled to the bus 26. Input devices may be connected to the processor 22 using interfaces such as, for example, a parallel port, game port, firewire, or a universal serial bus (USB). To view information from the processing device 20, a monitor 60 or other type of display device may also be connected to the bus 26 via an interface, such as a video adapter 62. In addition to the monitor 60, the processing device 20 may also include other peripheral output devices, not shown, such as speakers and printers.

As further illustrated in FIG. 1, the processing device 20 may also utilize logical connections to one or more system servers 68 which, in turn, may have an associated data repository in which is stored data related to products, pricing, bundles, etc. While the system server 68 has been illustrated in the exemplary form of a server computer, it will be appreciated that the system server 68 may be any type of device having processing capabilities. As such, it will again be appreciated that the system server 68 need not be implemented as a single device but may be implemented in a manner such that the tasks performed by the system server 68 are distributed to a plurality of processing devices linked through a communication network

For performing tasks as needed, the system server 68 may include many or all of the elements described above relative to the processing device 20. Communications between the processing device 20 and the system server 68 may be exchanged via a further processing device, such a network router, that is responsible for network routing. Communications with the network router may be performed via a network interface component 73. Thus, within such a networked environment 12, e.g., the Internet, World Wide Web, LAN, or other like type of wired or wireless network, it will be appreciated that program modules depicted relative to the processing device 20, or portions thereof, may be stored in the memory storage device(s) of one or more processing devices in communication therewith.

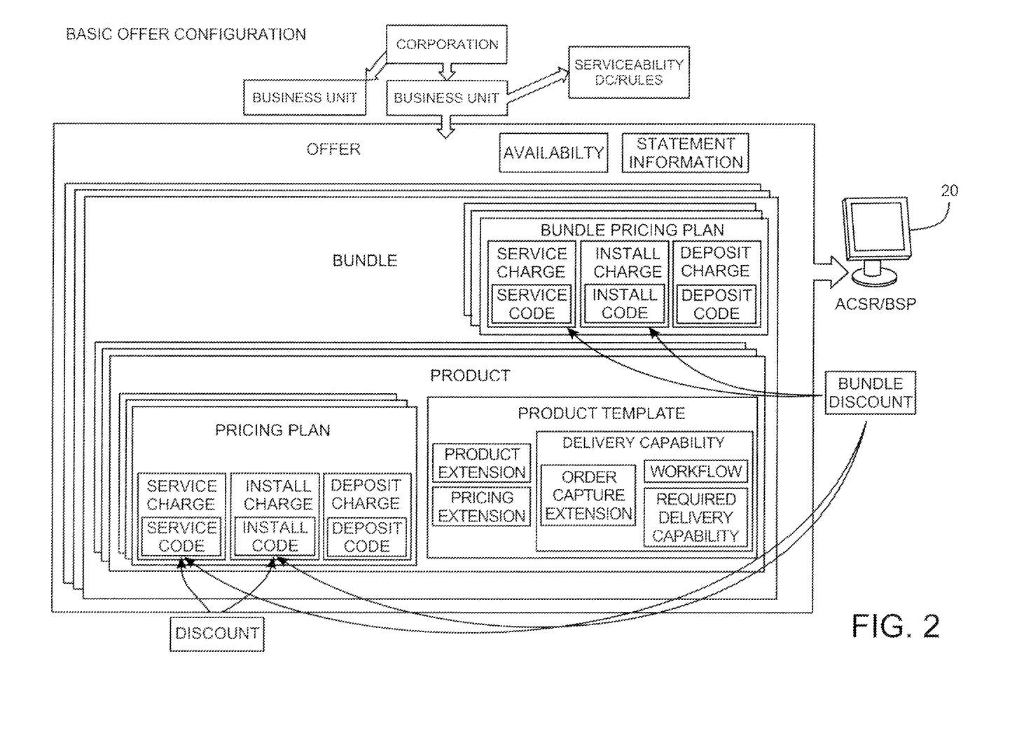

As noted above, the system server 68 generally makes available to a configuration administrator tools for allowing the configuration administer to access all of the options needed to create products, define pricing, organize products into bundles and offers, particularly as defined for a business unit within a corporate structure. The basic relationship or mapping between these various elements of an offer to be created via use of the tools is illustrated in FIG. 2. In general, the tools allow a user to plan offers from the top down, i.e., to define what products will be included in an offer, how services will be provisioned, and what will be charged for the different services (or bundle of services).

More particularly, the tools are generally in the form of wizards that are provided to allow a configuration administrator to perform one or more of defining a corporate structure, describe offers, define bundles and products, define discounts (if any), define offer availability, etc. As will be understood by those of ordinary skill in the art, such wizards may take the form of one or more linked pages that are used to obtain information from the configuration administrator, for example via selection of options provided by means of drop down menus, check boxes, or the like. As the options or steps on each page are completed, the configuration administrator advances through the wizard pages to further options or steps and, when the final step is completed, the particular configuration task associated with the wizard is finished.

A first wizard that is provided by the system is a wizard that provides options or steps by which the configuration administrator may define and/or modify a first data set that includes data indicative of a plurality of products to be offered/sold to a customer. By way of example only, the products may be associated with cable, satellite, etc. programming and services, Internet related services, phone services, etc. Generally, the first wizard is used to create a product (good or service) to be offered by a company.

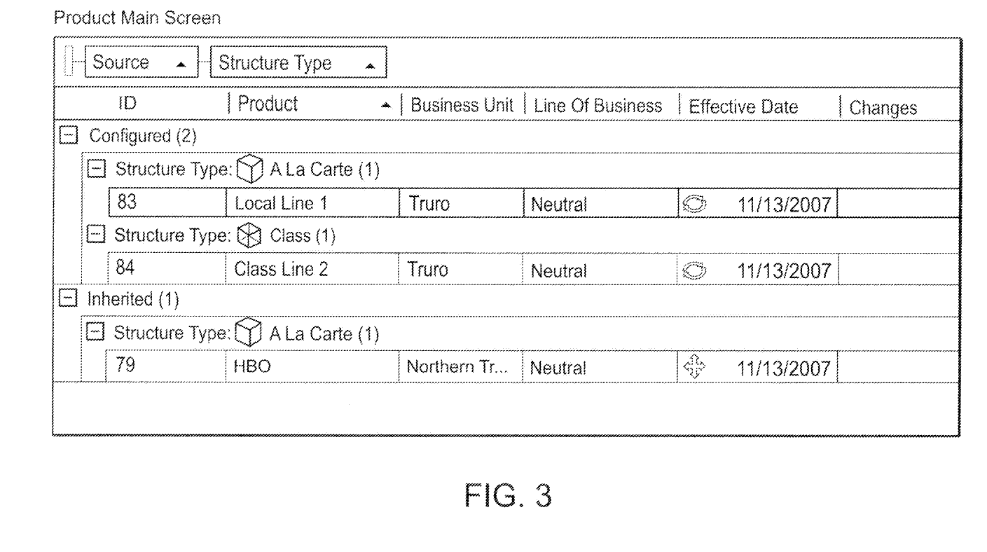

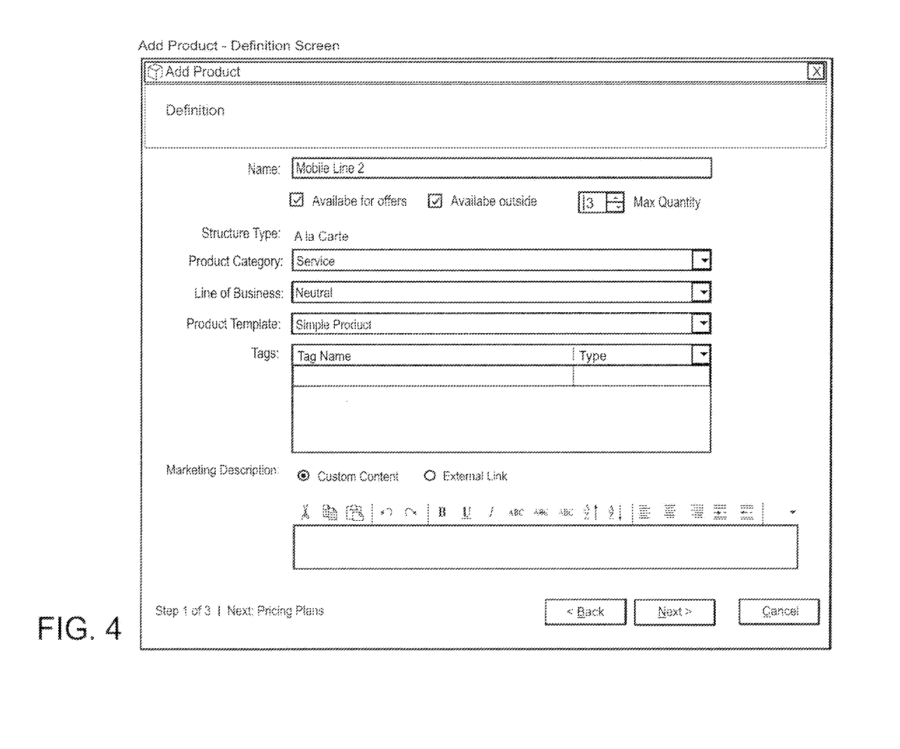

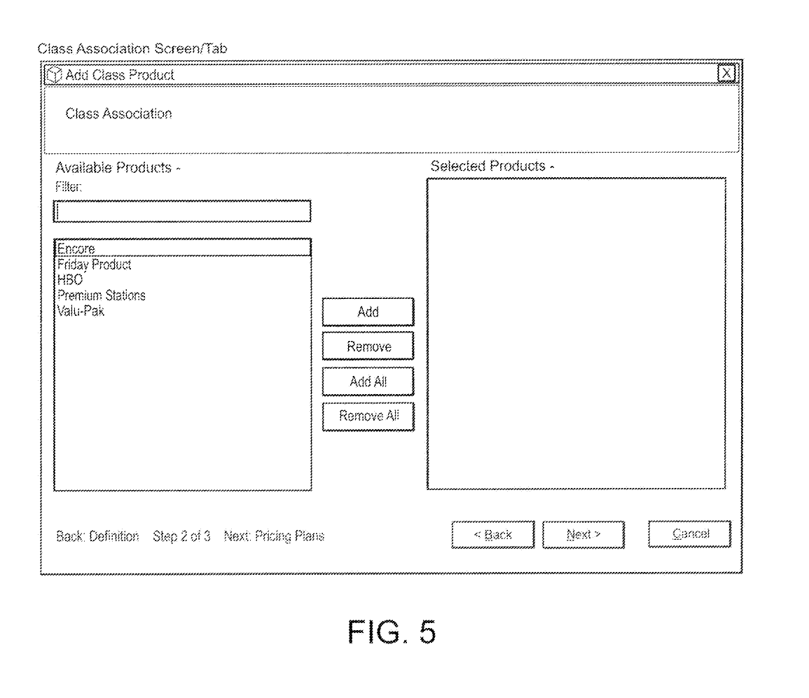

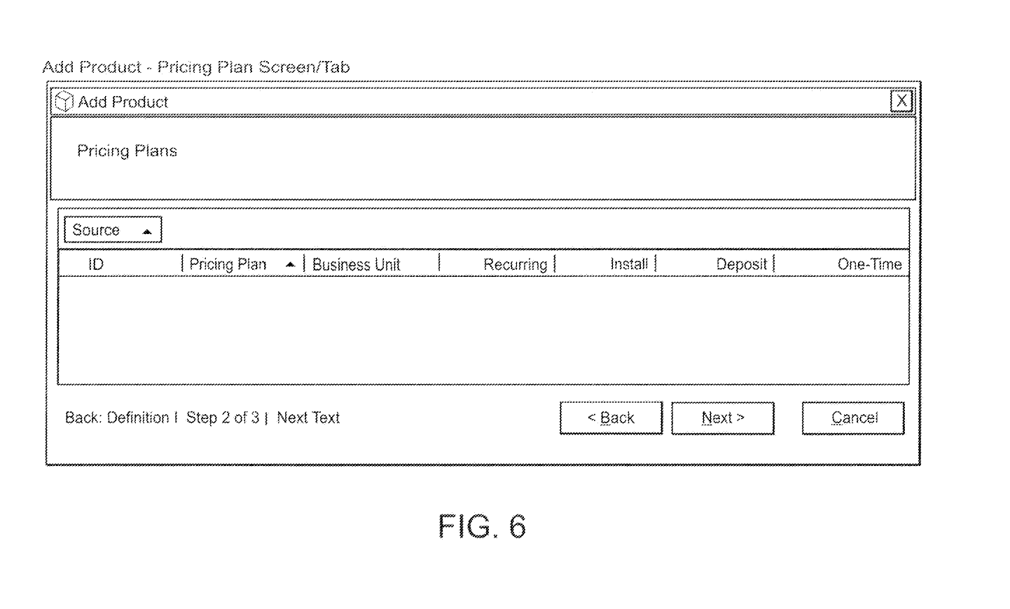

More particularly, via use of the first wizard a configuration administrator can define and group products together in several ways. For example, individual products can be set up with a structure type of a la carte, i.e., a product that can stand alone or be included in a bundle, bundle, i.e., a group of products that have default quantities and pricing, some of which may be modifiable when ordered, or class, i.e., a group of related products that can have custom pricing plans based on the number and combination of products selected within a class. Examples of wizard pages used to define the data structure for a product are illustrated in FIGS. 3-6. Generally, the wizard page of FIG. 3 allows the configuration administrator to indicate a source, or business unit, for a product, the structure type for a product, e.g., a la carte or class, an ID for the product, a date on which any changes on an offer moves into production, and whether or not any changes have been made in the product since it was moved into production; the wizard page of FIG. 4 allows the configuration administrator to provide a name for the product, designate a product as being available for an offer, designate a product as being a standalone outside of an offer, designate how many of the product may be available outside of an offer, and designate a category for the product, e.g., service, feature, equipment, merchandise, or labor; the wizard page of FIG. 5 allows the configuration administrator to add, remove, filter, and display products for a product class, e.g., to configure classes; and the wizard page of FIG. 6 allows the configuration administrator to create a pricing plan that is to be associated with a product.

As concerns pricing plans, it is to be appreciated that pricing plans define the billing characteristic of a product/bundle. A pricing plan may thus manage service charges, install charges, and deposit charges and, as such, determines the amount to be charged to the customer. Furthermore, different pricing plans may be made available for different products. Accordingly, a la carte and bundles may have standard pricing (pricing charged per item), bulk flat pricing (a fixed rate is charged for a pre-determined number of items), bulk unit pricing (a fixed rate that is charged per item), or quantity based pricing where pricing scenarios are associated with different pricing options such as tiered (a single unit price based on the number of products selected), incremental (various unit prices based on the number of products selected), fixed (a single unit price based on the number of products selected at a qualifying pricing level for each product), or mixed (a combination of fixed and incremental pricing). These exemplary pricing options are not intended to be limiting.

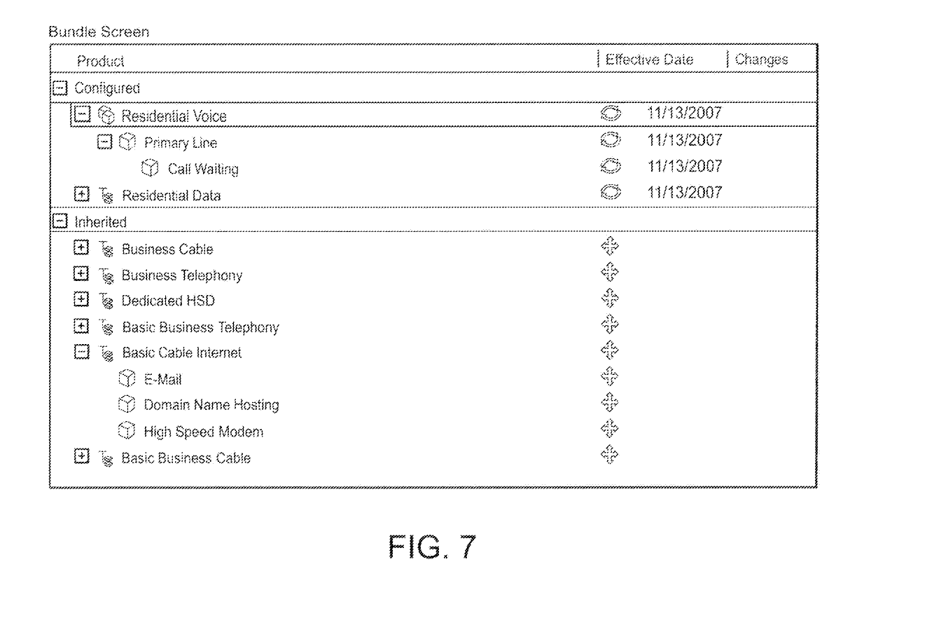

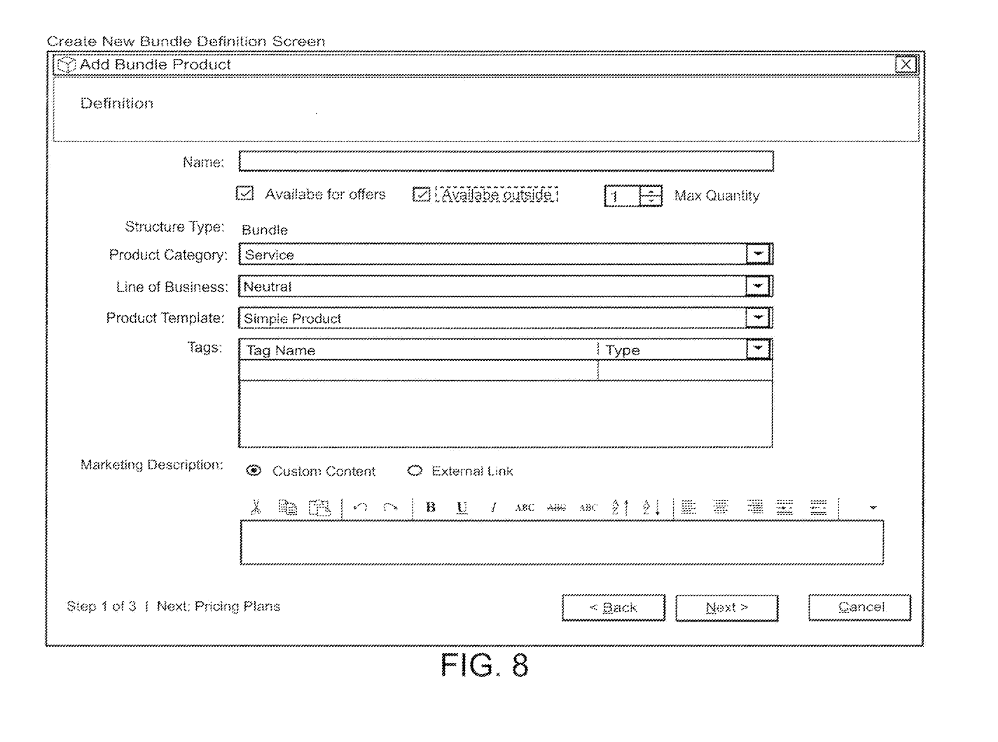

A second wizard is used to define and modify a second data set including data indicative of product bundles that include selected ones of the plurality of products to be offered to a customer. Generally, a bundle is a reusable group of products that are intended to be sold together. Thus, the second wizard provides wizard pages that allow the configuration administrator to view and/or create a configuration for a product bundle as illustrated in FIGS. 7 and 8, respectively.

More particularly, the bundle view page provides the configuration administrator with information such as the source, e.g., business unit, associated with the bundle, products included in the bundle, the date on which the bundle will be moved into production, and whether or not changes have been made to the bundle since it was moved into production. The create or add a bundle page provides the configuration administrator with a mechanism for creating the bundle container in which may be grouped any combination of a la carte products, class products, or even other bundles. Via the create or add a bundle page, the configuration administrator may provide a bundle with a name, designate if the bundle of products is available for an offer, designate how many of the bundle may be available outside of an offer, identify a line of business, e.g., voice, video, data, or neutral, designate a product category, and define a product template, e.g., how a product is to be ordered and delivered to a customer.

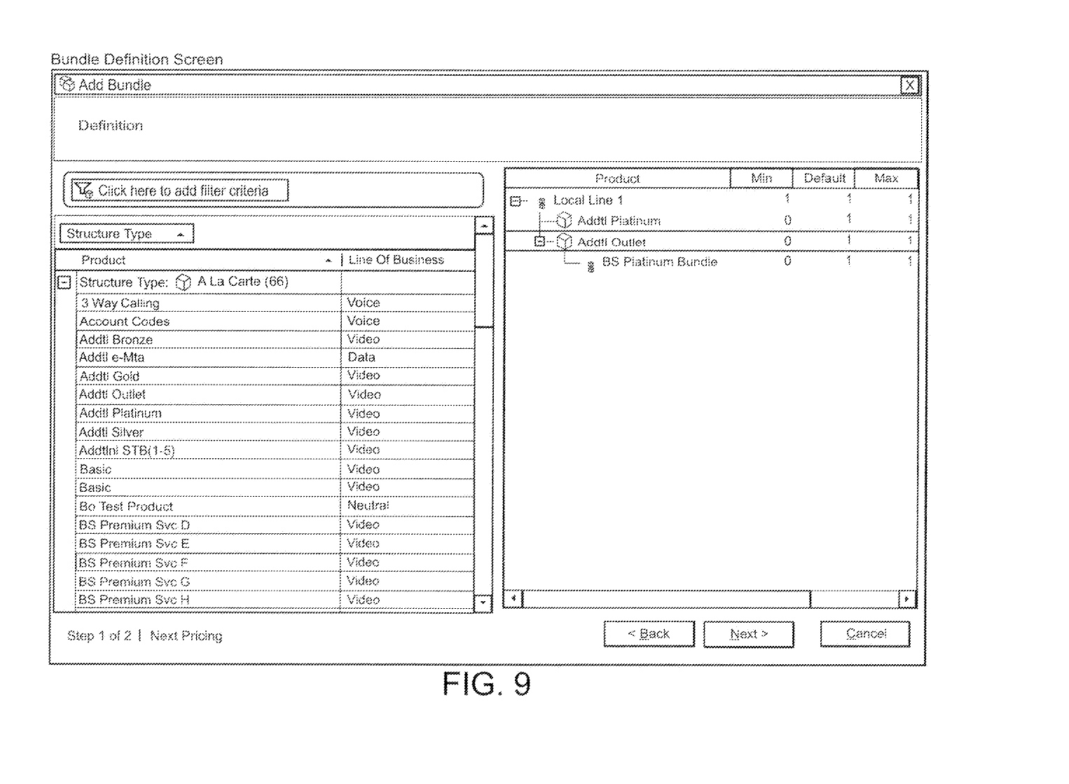

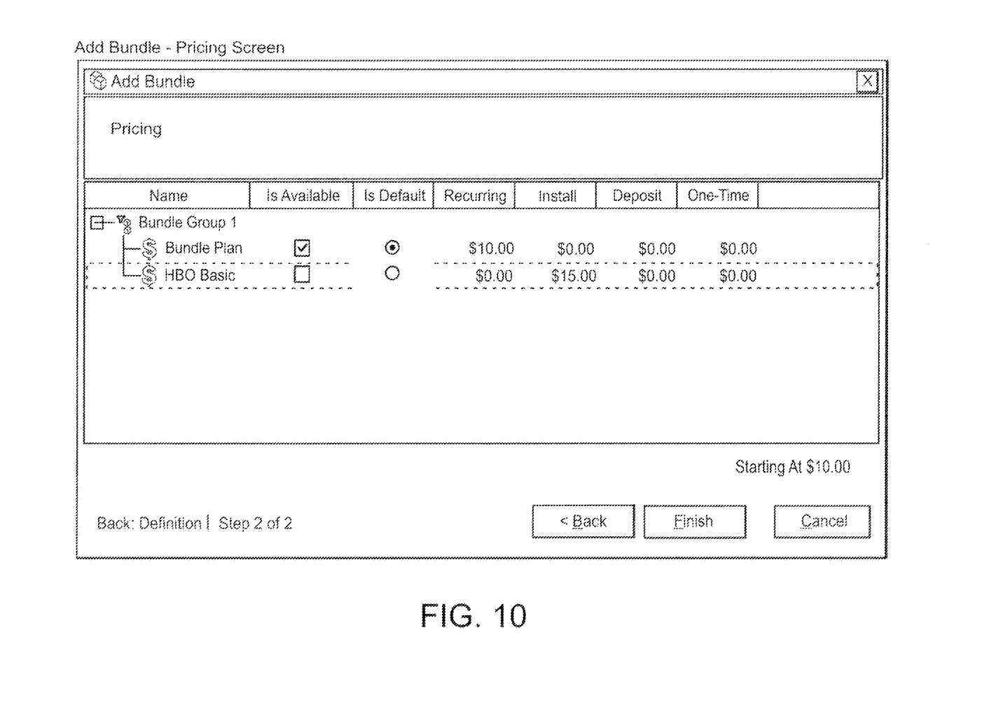

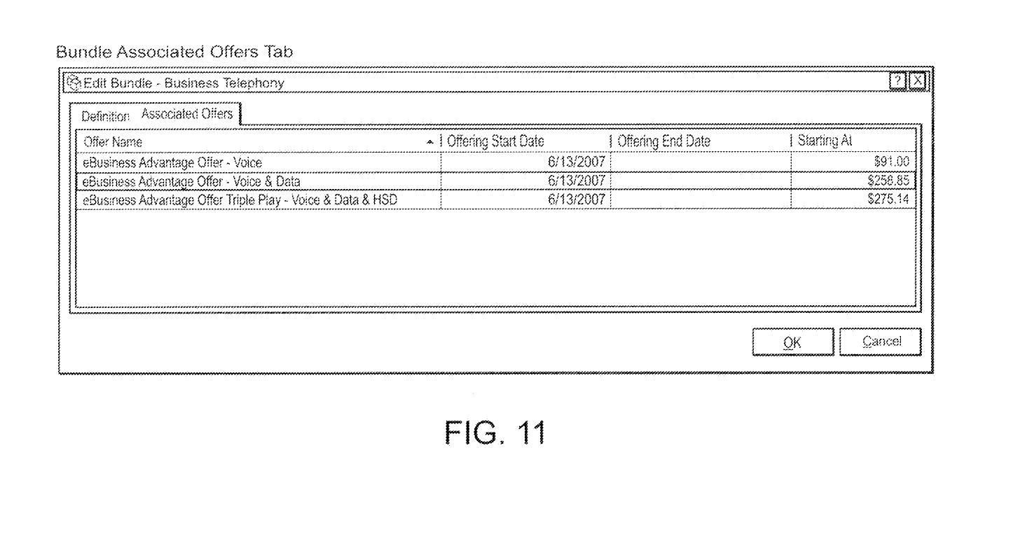

When the configuration administrator has completed use of the create a bundle wizard pages, the system will take the configuration administrator to the add bundle wizard definition pages, an example of which is illustrated in FIG. 9. In the illustrated example, the first bundle product listed is the bundle just created and, accordingly, is denoted with the structure type “bundle” as seen on the left section of the screen shot. As further seen, the left section of the screen also displays available products for a designated business unit. Via use of the add bundle wizard definition page, the configuration administrator may click and drag products from the left to the right to thereby add products to a bundle. Alternatively, a right-click operation can be used on a selected product to insert the product into a desired bundle. Products added to bundles may also be removed from a bundle and/or moved to other bundles via the user interface associated with this wizard page. As then illustrated in FIG. 10, a pricing wizard page is then made available to allow the configuration administrator to establish pricing plan/billing related data for a created bundle, e.g., to specify a price amount, if pricing is to recurring, if an installation charge is applicable, if a deposit is required, if pricing is one time, etc. A listing of offers associated with a selected bundle may also be viewed via the wizard page illustrated by way of example in FIG. 11. As seen, this wizard page may display to the configuration administrator a start date for an offer, i.e., when the offer can be ordered by a customer, an end date for an offer, i.e., when the offer can no longer be ordered by a customer, and a starting price for an offer.

A third wizard is provided to allow a configuration administrator to create and manage offers that are comprised of one or more products and/or product bundles. In this regard, an offer generally represents a grouping of services, pricing, and sales messaging that allow a market segment to be targeted. Services are defined by products and pricing plans where pricing plans determine the amount charged to the customer, e.g., a pricing plan may be defined by a monthly recurring charge (which could be zero), and/or an install charge, and/or a deposit.

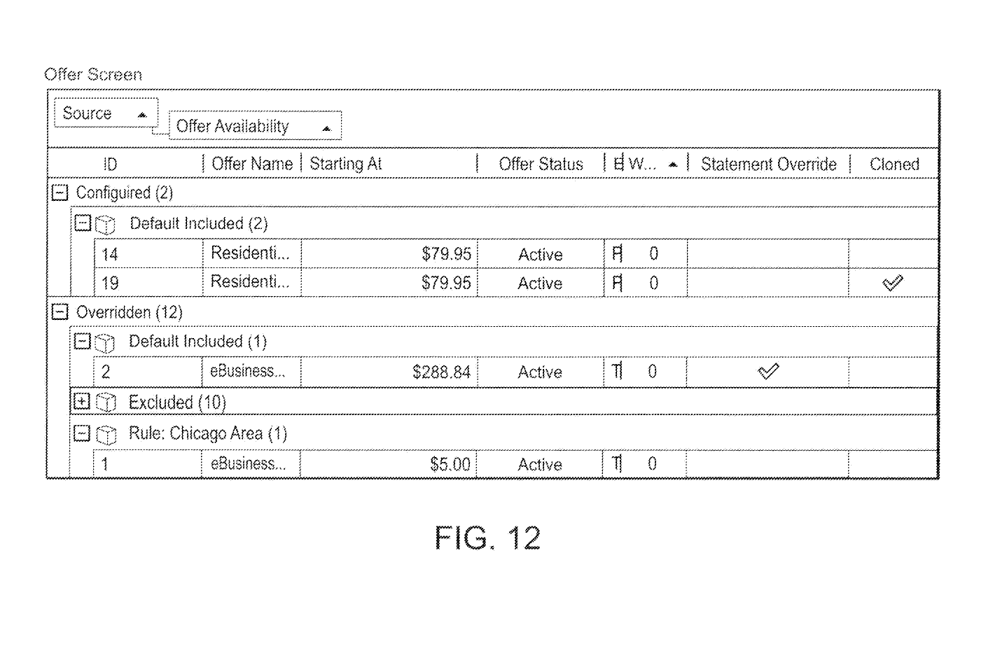

To view existing offers, i.e., offers that have been configured for a selected business unit, a view offers wizard page is provided as illustrated in FIG. 12. Via the exemplary wizard page illustrated in FIG. 12, the current status of existing offers can be viewed, e.g., active or unavailable, the starting price of offers can be viewed, the business unit associated with an offer can be viewed, a weight for an offer can be viewed, i.e., a rank value used to sort qualified offers for a customer, an indication whether an offer has been overridden, and an indication whether the offer has been cloned from another offer can be viewed. The listing of information may be filtered and sorted as desired using conventional techniques, such a tab clicking.

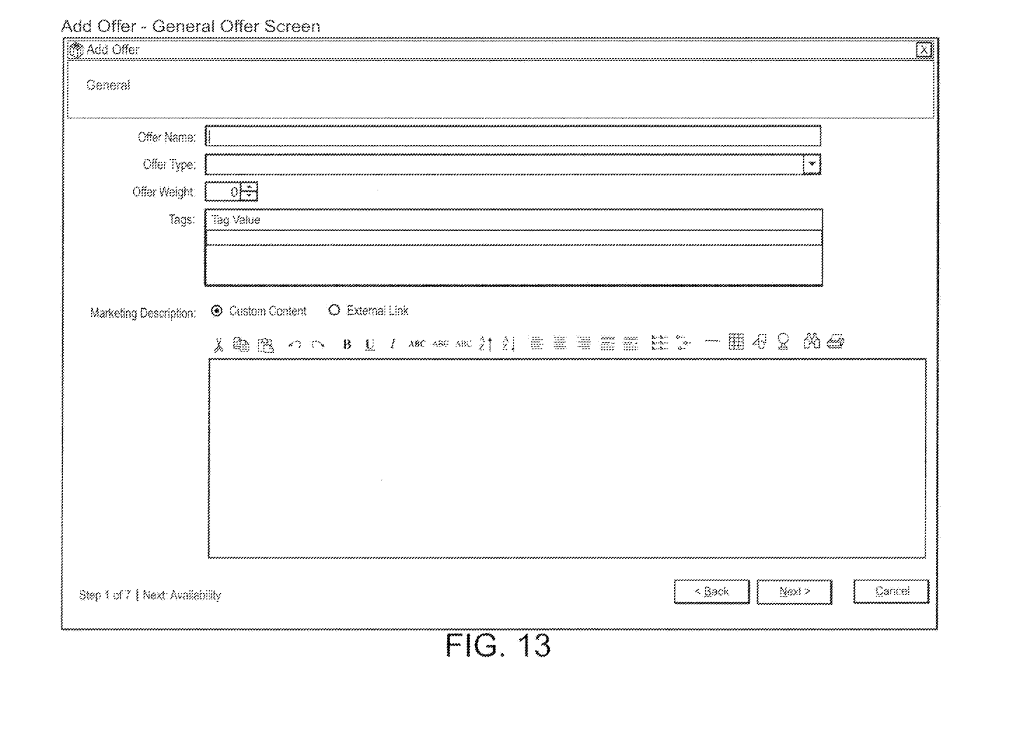

To create offers at any business unit level, an add general offer wizard page is provided, an example of which is seen in FIG. 13. This wizard page functions to capture basic information about an offer and allows for the entry of a description for the offer. Basic information may include the offer type, the offer weight, tags to be used for filters and searches, and a marketing description.

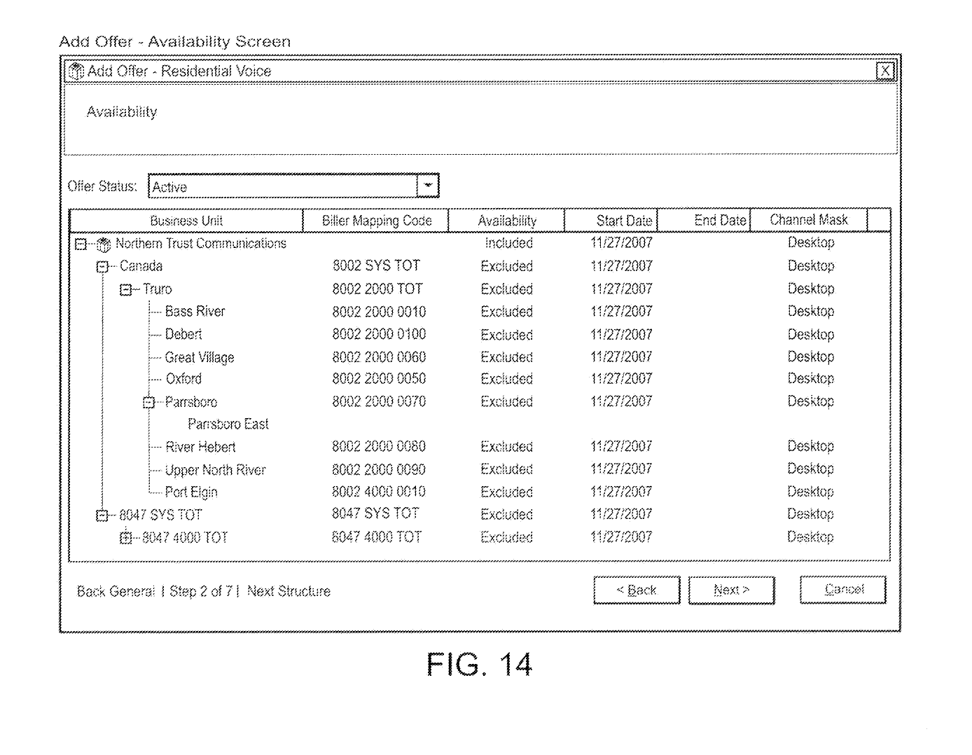

Once this information has been provided, the availability wizard page is invoked which displays the business unit hierarchy for the offer and indicates at what levels the offer is available. As example of this wizard page is seen in FIG. 14. When a new offer is created, it is automatically saved as included with the current date as the start date. Displayed for the business units is the offer status, biller mapping code (used to reconcile billing charges), offer availability, an availability icon (e.g., a green check mark to denote availability and a red circle icon to denote unavailability), an offer start date, an offer end date, and the channel(s) through which a customer can order this offer. In this illustrated example, a child business unit will inherit the offers associated within its parent with all inherited offers being automatically set to excluded. For a child business unit to have access to an offer, the offer availability must be overridden.

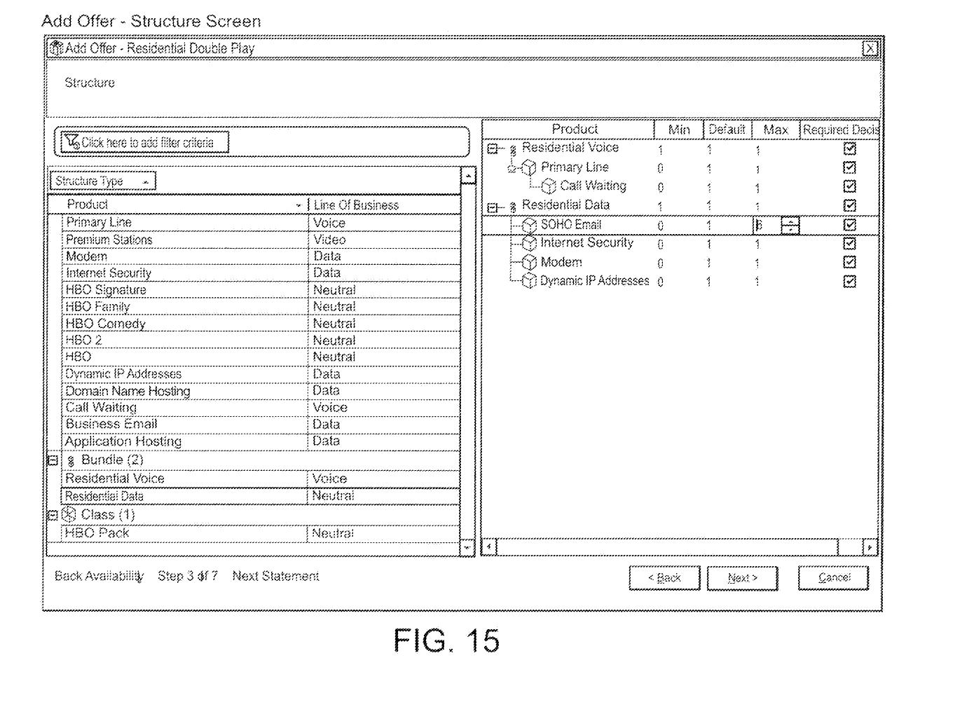

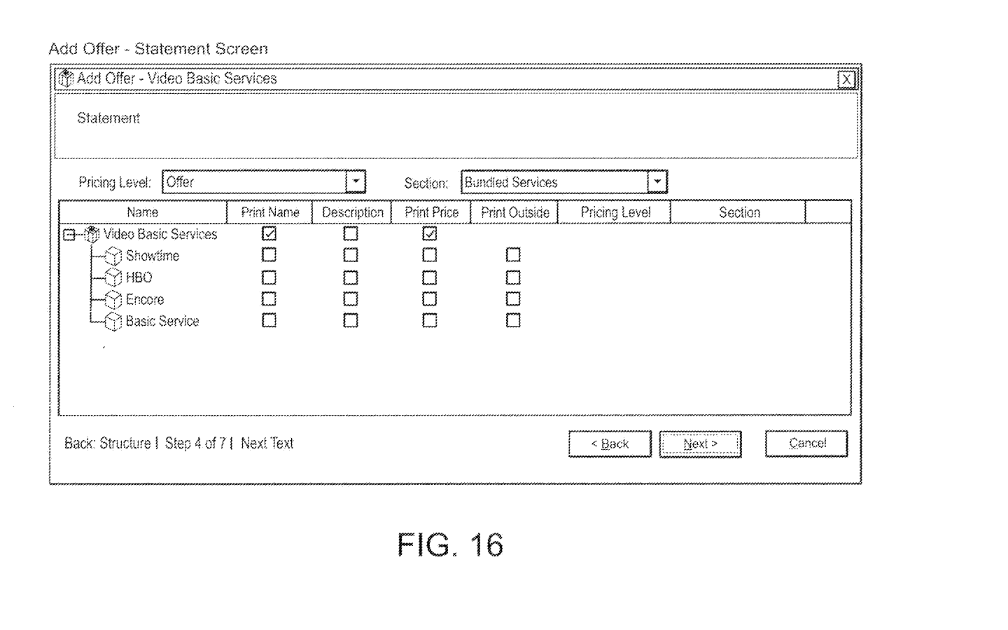

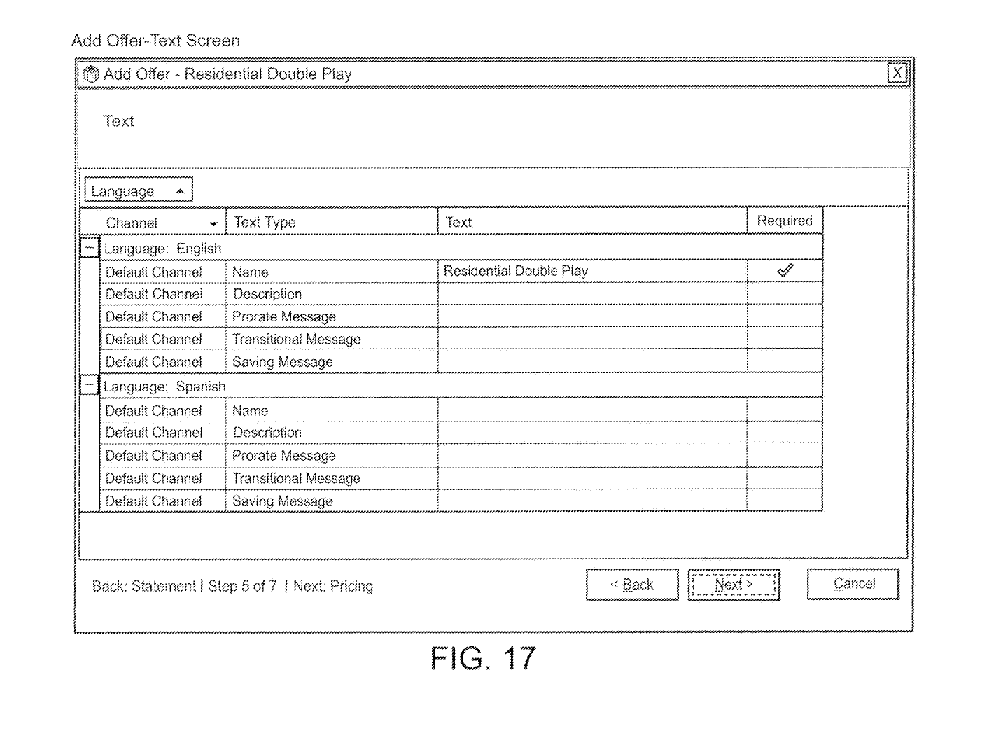

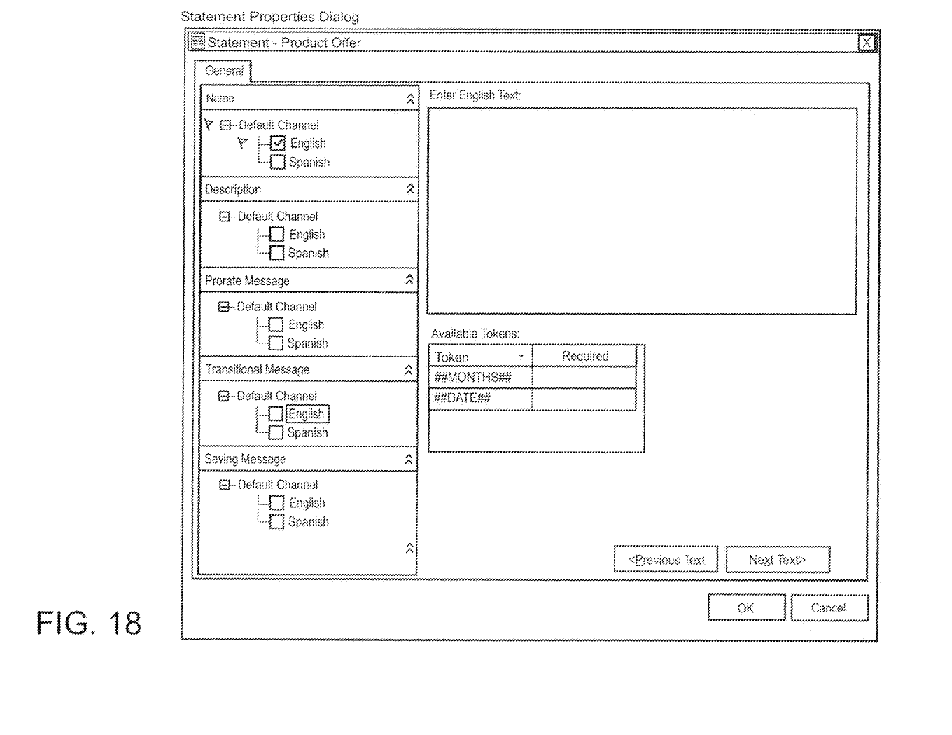

The add offer wizard page, an example of which is illustrated in FIG. 15, displays the products and bundles, e.g., in the left pane, that are available for a selected business unit. Through this wizard page, a configuration administrator may add bundles and products to an offer, as well as decide a minimum, maximum, and default number of instances the product can be ordered. As before, products and/or bundles may be added to an offer via a click and drag operation, removed from an offer, moved between offers, etc. However, once an offer is deployed, it is preferred that bundles and products not be allowed to be removed from the offer. The offer statement wizard page, seen in FIG. 16, allows the configuration administrator to set which details about this offer will be displayed on a customer's statement while the offer text wizard pages, seen in FIGS. 17 and 18, allows the configuration administrator to select and define the actual text to be printed on the customer's statement.

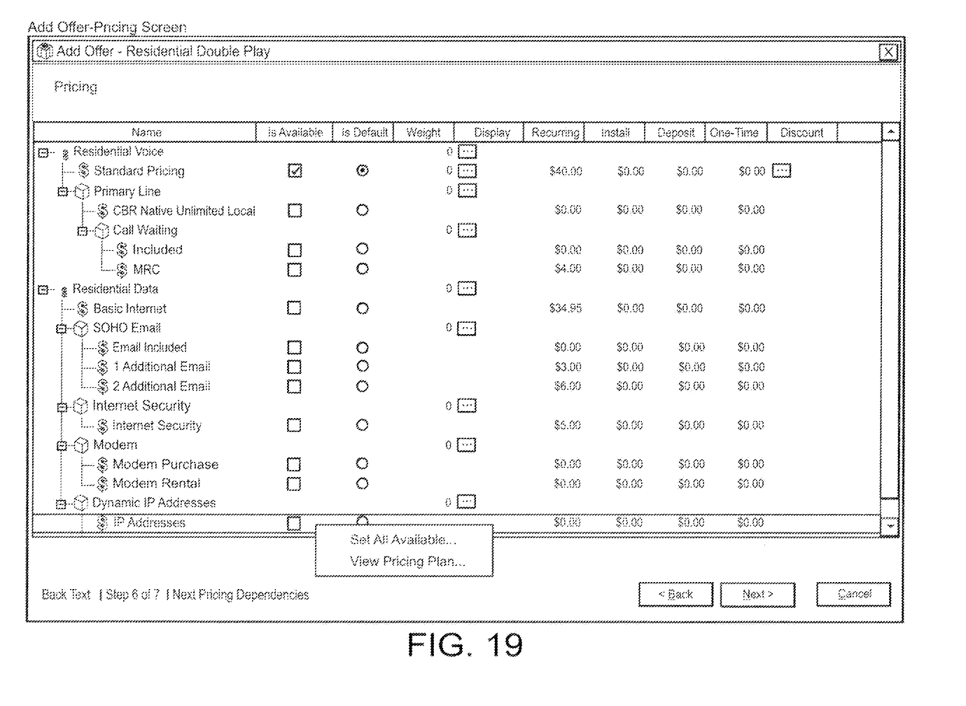

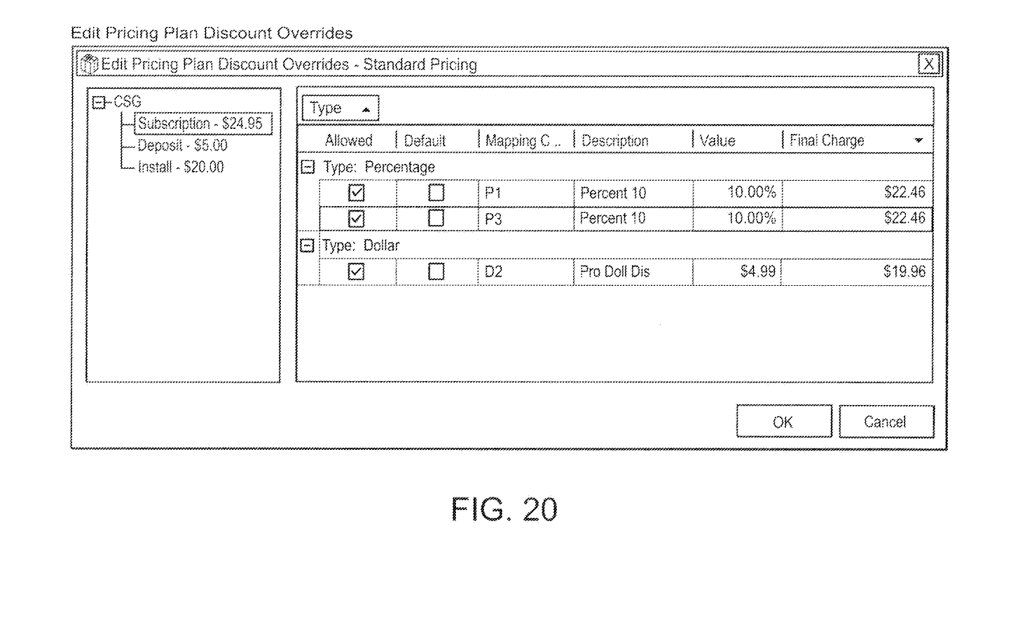

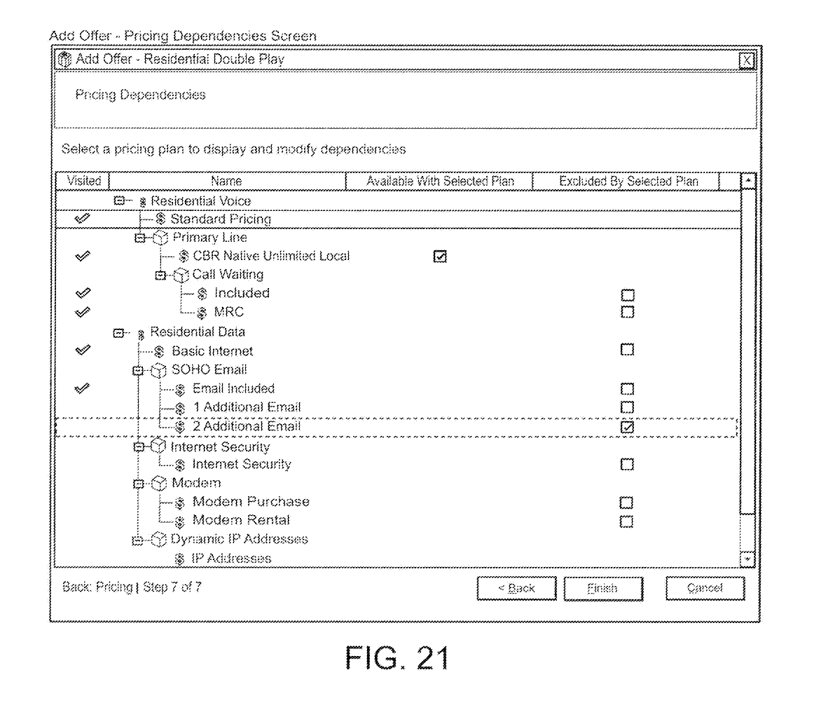

Turning to FIG. 19, an example of an offer pricing wizard page is shown. Via the user interface elements of this wizard page, the configuration administrator can decide which pricing plans are available and which are defaulted, can assign a weight to a product or pricing plan, add a description to a pricing plan, and view information about charges. Via this wizard page, the configuration administrator may also override or set any discount information established for a particular pricing plan in the offer. To this end, a dialog box such as illustrated in FIG. 20 may be presented to the configuration administrator. Finally, the wizard for creating offer related data presents an offer pricing dependencies page which allows the configuration administrator to decide which pricing plans are available in conjunction with other pricing plans from the parent product, e.g., it may be desired to limit customers who only purchase lower cost plans from purchasing other features while it may be desired to reward customers who select higher priced plans with more features or better pricing.

As will be appreciated, these described wizards may themselves include further tools, or be used in connection with other tools, that are used to define and/or modify additional data that is associated with the general categorizations of data above-noted. For a better understanding of such additional wizards and tools the reader is referred to the parent, provisional application which is incorporated herein by reference in its entirety. As will also be appreciated, the data sets defined via use of the aforementioned wizards are stored in a database along with a mapping relationship therebetween, such as seen in FIG. 2 which illustrates data sets defined for a particular organization. In this regard, it will be appreciated that different organizations may offer differing products, product bundles, pricing, discounts, billing, etc. Thus, an additional wizard may be used to create and modify organizational data under which the data above-described would be mapped as applicable to an organization thus created.

While specific embodiments of the invention have been described in detail, it will be appreciated by those skilled in the art that various modifications and alternatives to those details could be developed in light of the overall teachings of the disclosure. For examples, the wizards above described need not be separate and distinct wizards but may be component parts, e.g., pages, provided as a part of a larger wizard, i.e., a wizard that serves multiple functions. Accordingly, the particular arrangements disclosed are meant to be illustrative only and not limiting as to the scope of the invention which is to be given the full breadth of the appended claims and any equivalents thereof.

What is claimed is:

1. A system for defining products and billing for the same implemented, comprising:
a server having programming for providing an interactive wizard comprised of a plurality of wizard pages, the wizard pages providing interactive elements for: defining and modifying a first data set including data indicative of a plurality of products to be offered to a customer; defining and modifying a second data set including data indicative of product bundles including selected ones of the plurality of products to be offered to a customer; defining and modifying a third data set including data indicative of prices associated with the plurality of products and product bundles; defining and modifying a fourth data set including data indicative of how the plurality of products and product bundles are to be billed to a customer; and defining and modifying a fifth data set including data indicative of how the plurality of products and product bundles are offered to a customer for purchase; and
a database in communication with the server in which is stored the first data set, second data set, third data set, fourth data set, and fifth dataset and a mapping therebetween.

2. The system as recited in claim 1, wherein the first data set, second data set, third data set, fourth data set, and fifth data set are defined for a business unit.

3. The system as recited in claim 1, wherein the products comprise cable television services.

4. The system as recited in claim 1, wherein the products comprise Internet services.

5. The system as recited in claim 1, wherein the products comprise phone services.

6. The system as recited in claim 5, wherein the products comprises cellular phone services.

7. The system as recited in claim 1, wherein the data indicative of how the plurality of products and product bundles are offered to a customer for purchase includes data indicative of customer discounts.

8. The system as recited in claim 1, comprising a means for accessing the data stored in the database for presentation to a customer service representative.
